(19) United States
(12) Patent Application Publication
(10) Pub. No.: US 2026/0340187 A1
(43) Pub. Date: Oct. 29, 2026

(54) INLINE PROTECTION OF SENSITIVE DATA ITEMS

(71) Applicant: Microsoft Technology Licensing, LLC, Redmond, WA (US)

(72) Inventors: Ross A. WOLLMAN, San Francisco, CA (US); Michael C. FANNING, Redmond, WA (US); Sayed Ibrahim HASHIMI, Jacksonville, FL (US)

(21) Appl. No.: 19/192,950

(22) Filed: Apr. 29, 2025

(51) Int. Cl. G06F 21/62; G06F 21/64

(52) U.S. Cl. CPC G06F 21/6254; G06F 21/64

(57) ABSTRACT

Some embodiments detect keys or other sensitive data in a document, and modify the document or surrounding data structures in order to prevent disclosure of protected data. Some modifications transform sensitive data inline, and some modifications replace the sensitive data with a reference to a copy of the sensitive data in a secure store. In some scenarios, the secure store is created specifically for the detected data. The document is not necessarily complete at the time of modification; some documents are streamed. Some embodiments base the modification at least partially on one or more of: a risk assessment, metadata embedded in the sensitive data, sensitivity level, trust level, intended recipient, policy, or regulatory requirements, for example.

### BACKGROUND

Attacks on a computing system may take many different forms, including some forms which are difficult to predict, and forms which may vary from one situation to another. Accordingly, one of the guiding principles of cybersecurity is “defense in depth”. In practice, defense in depth is often pursed by identifying and closing security gaps, and by forcing attackers to encounter multiple different kinds of security mechanisms at multiple different locations around or within the computing system. No single security mechanism is able to identify every vulnerability or detect every kind of cyberattack, able to determine the scope of an attack or a vulnerability, able to remove every vulnerability, and able to end every detected cyberattack. But sometimes combining and layering a sufficient number and variety of defenses and investigative tools will prevent an attack, deter an attacker, or at least help limit the scope of harm from an attack or a vulnerability.

To implement defense in depth, cybersecurity professionals consider the different kinds of attacks that could be made against a computing system, and the different vulnerabilities the system may include. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place or removing a particular vulnerability to attack. They investigate the scope of an attack, and try to detect vulnerabilities before they are exploited in an attack. Some defenses or investigations might not be feasible or cost-effective for a particular computing system. However, improvements in cybersecurity remain possible, and worth pursuing.

### SUMMARY

Some embodiments address technical challenges arising from activities that transmit sensitive data. One challenge is how to reduce computational costs of sensitive data protection relative to document encryption approaches, without decreasing security of the sensitive data. Another challenge is how to protect sensitive data at a processing speed which is sufficiently fast to permit protection of streamed data without delays that degrade user experience. Another challenge is how to integrate sensitive data protection with secure data vaults or other secure data storage mechanisms. Other technical challenges of sensitive data protection are also addressed herein.

One example embodiment detects a sensitive data item which is embedded in a digital document, modifies the digital document by substituting a substitution data item for the sensitive data item within a focused portion of the digital document, and forwards the modified digital document. In some scenarios, the substitution data item includes a result of a reversible transformation of the sensitive data item. In some scenarios, the substitution data item includes a reference to a location in a secure store which stores a copy of the sensitive data item.

Additional technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description is given with reference to the attached drawings. These drawings only illustrate selected aspects and thus do not fully determine coverage or scope.

FIG. 1 is a diagram illustrating aspects of computer systems, including some aspects generally suitable for enhanced systems which include or use inline protection of sensitive data items (IPSDI) functionality;

FIG. 2 is a block diagram illustrating aspects of a first example family of enhanced systems which are each configured with IPSDI functionality;

FIG. 3 is a dataflow diagram of a second example family of enhanced systems which are each configured with IPSDI functionality;

FIG. 4 is a block diagram illustrating aspects and examples related to substitution of other data for sensitive data;

FIG. 5 is a block diagram illustrating aspects and examples related to a secure data store;

FIG. 6 is a block diagram illustrating aspects and examples related to some sensitive data items;

FIG. 7 is a block diagram illustrating aspects and examples related to reversibility restriction on some transformations of sensitive data;

FIG. 8 is a first flowchart illustrating some IPSDI methods;

FIG. 9 is a second flowchart illustrating some IPSDI methods;

FIG. 10 is a third flowchart illustrating some IPSDI methods;

FIG. 11 is a fourth flowchart illustrating some IPSDI methods;

FIG. 12 is a fifth flowchart illustrating some IPSDI methods; and

FIG. 13 is a sixth flowchart further illustrating IPSDI methods, and incorporating as options the steps of each of FIGS. 8 through 12, and also other steps disclosed herein.

### DETAILED DESCRIPTION

### Overview

Some teachings described herein reflect technical challenges faced and insights gained during efforts to improve cybersecurity tools. However, the teachings herein are not limited in their scope or applicability to this particular kind of software, or to these particular challenges, solutions, or insights, or to the particular application fields used as examples.

One approach to protecting sensitive data within a document is to encrypt the entire document, or at least to encrypt all (or nearly all) of the human-readable portion of the document. Document metadata is not necessarily encrypted, e.g., document name, path to local storage, creation time, last modified date, author identifier, display style data, font, file size, and version data. In some scenarios, metadata such as the document name and the path to a storage location (including a file name) is human-readable, but nonetheless is not encrypted. But in a word processor document, for example, all of the text which has been entered into the document via a word processor user interface will be encrypted. Similarly, in a spreadsheet document all of the text (cell numeric values, cell text content, column labels) that was entered into the document via a spreadsheet application user interface will be encrypted. Similar approaches are taken with other user-generated data in other kinds of application programs. Encrypting all or nearly all of the human-readable content encrypts and thereby protects sensitive data which is embedded in that content, e.g., passwords and other pass phrases, keys represented as alphanumeric strings, account numbers, financial data, and personally identifiable information.

Some embodiments described herein take a different approach, referred to here as inline protection of sensitive data items (IPSDI). These embodiments detect a sensitive data item which is embedded in a digital document, modify the digital document by substituting a substitution data item for the sensitive data item within a focused portion of the digital document, and forward the modified digital document. In some scenarios, the substitution data item includes a result of a reversible transformation of the sensitive data item. In some scenarios, the substitution data item includes a reference to a location in a secure store which stores a copy of the sensitive data item. By focusing on a portion of the document, instead of encrypting all or nearly all of the document, these embodiments reduce computational costs, increase processing speed, and provide other technical benefits.

In some IPSDI embodiments, a computing system performs a method which includes: detecting a sensitive data item which is embedded in a digital document, the sensitive data item being less than an entire human-readable portion of the entire digital document; modifying the digital document by substituting a substitution data item for the sensitive data item within the digital document, the substituting reversible in that the substitution data item is free of redaction relative to the sensitive data item; and forwarding the modified digital document.

In this example, the focused portion of the digital document is defined as “less than an entire human-readable portion of the entire digital document”. This is one example of focus 1302. In some variations, the focused portion of the digital document is defined alternately or in addition as “sensitive data item which is embedded in a digital document and which occupies less than three-quarters of the digital document by size”, or “a portion of the digital document contains sensitive data which is detected by the sensitive data detection procedure [and] the total sensitive data size is between eighty percent and one hundred percent of the document portion size”, or “the substitution data [which is substituted for the sensitive data] being less than a third by size of the entire digital document”. Other definitions of focus will also be apparent to one of skill in view of the teachings provided herein. A technical advantage of some embodiments taught herein is that they leave a large portion of a digital document in a readable condition. By contrast, when a user account encrypts a document, the document's content is generally inaccessible unless the document is decrypted in its entirety. In some embodiments, however, most of the document remains accessible while the in-lined protection keeps secret embedded data locked away from easy access. This facilitates access to non-secret content when a digital document is reviewed, e.g., in an untrusted environment, such as when a device containing the document is connected to a public network in an airport or a coffeehouse.

This IPSDI functionality has a technical benefit of increased security by the detection of sensitive data in scenarios where whole document encryption is not performed. For example, in some scenarios whole document encryption was performed only in response to a user request and no such request was received. In some scenarios, encryption was not implemented. The present approach increases sensitive data security relative to those scenarios.

This IPSDI functionality also has a technical benefit of faster processing due to the focus. In some cases, only the sensitive data is encrypted instead of also encrypting document content that is not sensitive. In many cases, even though some non-sensitive document content is also encrypted along with the sensitive content, the focus portion is smaller than the portion that would have been encrypted under a whole document encryption approach, so processing is faster than the whole document encryption approach.

Similarly, this IPSDI functionality has a technical benefit of decreased computational cost due to the focus. Only the sensitive data itself, or a focus portion of the document containing the sensitive data, is encrypted, otherwise transformed, or otherwise substituted, thereby avoiding the cost of processing some or all of the document content that is not sensitive.

This IPSDI functionality also has a technical benefit of solving an inconsistent protection problem which arises from an ad hoc approach to sensitive data protection. Depending on a user's choice at the moment, a password could be shared in plain text within a video conferencing system chat, in plain text in an email, in plain text in a social networking application direct message, in a voice phone call or a voice mail, in a phone Short Message Service (SMS) text, or through some other channel. This ad hoc approach results in varied security or no security at all for the password, depending on what protective steps—if any—are taken in the channel chosen in the moment by the user. Not infrequently, the channel is chosen based on user convenience or user familiarity with the channel, not on the level or kind of security provided. By contrast, in embodiments taught herein the sensitive data is detected and then protected by substitution according to predefined security criteria. The substitution removes the sensitive data from the document and replaces it with a transformation result (e.g., encryption) or a reference to a copy of the sensitive data in a secure store. Thus, the level of protection is more consistent, because the choice of protective steps is no longer subject to a user choice made on the spur of the moment.

In some embodiments, the substitution data item includes a result of a reversible transformation of the sensitive data item, including generating the substitution data item by transforming the sensitive data item by at least one of: encrypting the sensitive data item, reversibly obfuscating the sensitive data item, or reversibly pseudonymizing the sensitive data item.

This IPSDI functionality has technical benefits of faster transformation processing due to the focus, and decreased transformation computational cost due to the focus. In some cases, only the sensitive data is transformed instead of also transforming document content that is not sensitive. In many cases, even though some non-sensitive document content is also transformed along with the sensitive content, the focus portion is smaller than the portion that would have been encrypted under a whole document encryption approach, so processing is faster and uses less computational resources (processor cycles, memory space, bandwidth, electricity) than the whole document encryption approach.

In some embodiments, the substitution data item includes a reference to a location in a secure store, the sensitive data item being unretrievable from the secure store via the reference in the absence of a retrieval authorization, and the method includes: transmitting a copy of the sensitive data item to the secure store; and keeping the modified digital document free of the retrieval authorization while forwarding the modified digital document.

This IPSDI functionality has a technical benefit of efficient integration of focused sensitive data protection into secure storage functionality in a computing system. This integration reduces the inconsistent protection problem noted above by implicitly or explicitly utilizing the security controls, policies, audit capabilities, administrative controls, and other aspects of the secure storage functionality. This integration with a secure store also beneficially provides scalability in some scenarios, by leveraging a secure store which is designed and implemented to be scalable, unlike an ad hoc approach using voice calls, voice mail, or phone SMS texts, for example.

In some embodiments, the method extracts metadata from the sensitive data item, and selects the secure store in response to at least the metadata. In some embodiments, examples of embedded metadata include one or more of timestamp metadata, deployment metadata, origination metadata, test metadata, or test behavior metadata.

This IPSDI functionality has a technical benefit according to the kind of metadata embedded in the sensitive data item. Timestamp metadata facilitates detection of security keys or other sensitive data items which have expired, or which are within a specified tolerance of expiration, which promotes better governance of sensitive data. In some scenarios, timestamp metadata facilitates security incident investigations or minting mechanisms by marking security keys or other sensitive data items which were minted within a specific time period. Deployment metadata and origination metadata promote efficient and effective sensitive data governance by associating information about the authorized deployment scope or origination of a sensitive data item within the item itself. This avoids delays and access failures caused by alternate approaches that attempt to retrieve such information about an item from a location that is remote from the item. Test metadata and test behavior metadata facilitate validation or testing of security mechanisms without risking exposure of actual sensitive data.

In some embodiments, the method includes sending a hash of the sensitive data item to a risk assessor, receiving a risk assessment of the sensitive data item from the risk assessor, and choosing the substitution data item in response to at least the risk assessment. This IPSDI functionality has a technical benefit of reducing the inconsistent protection problem noted above by implicitly or explicitly utilizing the security controls, policies, audit capabilities, administrative controls, and other aspects of the risk assessor.

In some embodiments, in response to detecting the sensitive data item, the method transmits the copy of the sensitive data item to a local secure storage mechanism which is on a same machine as the sensitive data item, the local secure storage mechanism thereby being the secure store. Data transmission in this embodiment means moving data (which can be performed by sending a copy or by moving an original) within the machine, and does not require a copy of the data on a network located outside the machine; each of the following is a transmission: moving data from one RAM location in the machine to another RAM location in the machine, moving data from volatile memory in the machine to non-volatile memory in the machine, or moving data over a virtual network which resides entirely within the machine. In some variations the transmitted copy is an encrypted copy of the sensitive data item, in others it is not. Encryption occurs prior to transmission, during transmission, upon receipt of the transmitted copy, or a combination thereof, depending on the embodiment.

This IPSDI functionality has a technical benefit of reducing bandwidth usage of networks which are outside the machine, because the secure store and the transmission in these embodiments are local to the machine.

These and other advantages and benefits will be apparent to one of skill from the teachings provided herein.

### Operating Environments

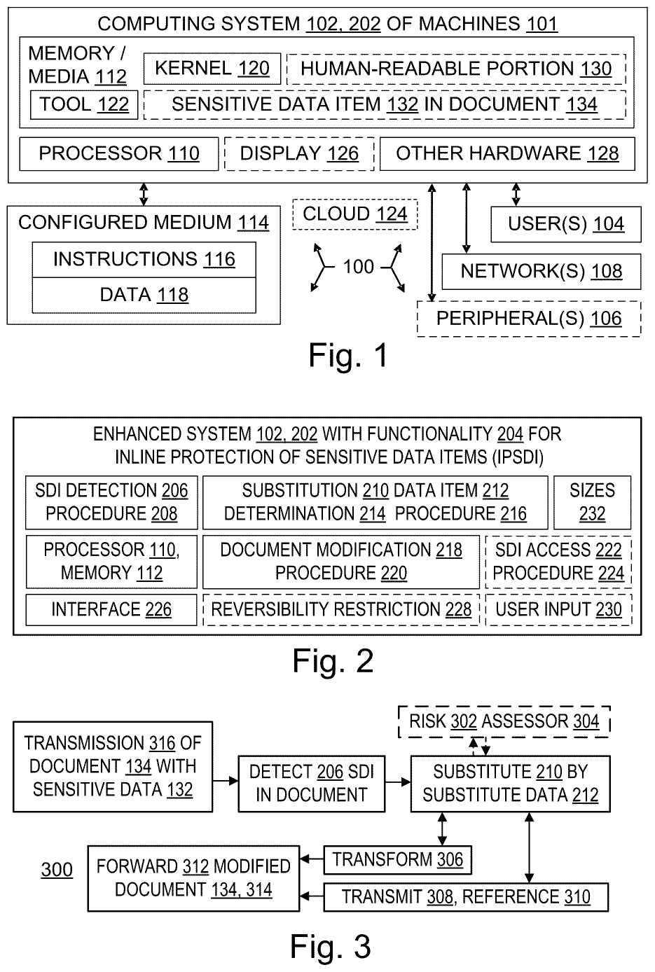

With reference to FIG. 1, an operating environment 100 for an example embodiment includes at least one computer system 102. The computer system 102 may be a multiprocessor computer system, or not. An operating environment may include one or more electrically-powered machines 101 in a given computer system, which may be clustered, client-server networked, and/or peer-to-peer networked within a cloud 124. An individual machine 101 which includes a processor 110 and a digital memory 112 is a computer system, and a network or other non-empty cooperating group of such machines 101 is also a computer system. A given computer system 102 may be configured for end-users, e.g., with applications, for administrators, as a server, as a distributed processing node, and/or in other ways.

System administrators, network administrators, cloud administrators, security analysts and other security personnel, operations personnel, developers, testers, engineers, auditors, and end-users are each a particular type of human user 104. Human users 104 sometimes interact with a computer system 102 user interface by using displays 126, keyboards 106, and other peripherals 106, via typed text, touch, voice, movement, computer vision, gestures, and/or other forms of I/O (input/output). Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

Storage devices or networking devices or both are considered peripheral equipment 106 in some embodiments and integral parts of a system 102 in other embodiments, depending on their physical detachability from an electrical connection to the processor 110 hardware. In some embodiments, other computer systems not shown in FIG. 1 interact in technological ways with the computer system 102 or with another system embodiment using one or more connections to a cloud 124 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, editors, compilers, debuggers and other software development tools, document processing tools, as well as APIs, browsers, or webpages and the corresponding software for protocols such as HTTPS. Files, APIs, endpoints, and other resources may be accessed by an account or non-empty set of accounts, user or non-empty group of users, IP address or non-empty group of IP addresses, or other computational entity.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system 102 when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks (solid state or magnetic or optical), and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

A storage device 114 is sometimes configured with binary instructions 116 that are executable by a processor 110; “executable” is used in a broad sense herein to include machine code, interpretable code, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, physical measurements, sensor data, and so forth.

Although an embodiment may include software instructions executed by one or more processors in a computing device, such description is not meant to exhaust all possible embodiments. Embodiments do not necessarily include any software. One of skill will understand that the same or similar functionality of software can often be implemented, in whole or in part, directly in hardware logic, to provide the same or similar technical effects. Alternatively, or in addition to a software implementation, technical functionality can be performed, in some examples, by one or more hardware logic components. For example, and without excluding other implementations, some embodiments include one or more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip (SoC) components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) are present in operable communication with one or more processors 110 and memory 112.

In some embodiments or operating environments, a system includes multiple computers connected by a wired and/or wireless network 108. Networking interface equipment 128 provides access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments or operating environments, one or more computers are partially or fully “air gapped” by reason of being disconnected from, or only intermittently connected to, another networked device or remote cloud or the internet. Some examples also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some example embodiments, but are not required in every embodiment. This document's headings do not provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be properly added to designate items disclosed in the current application. Such items may include, e.g., software, hardware, steps, processes, systems, functionalities, mechanisms, connections, devices, data structures, kinds of data, settings, parameters, components, computational resources, workflows, or algorithm implementations, or other items in a computing environment, which are disclosed herein but not tied to a particular reference numeral. Corresponding drawings may also be properly added.

### More About IPSDI Systems

Specific items called out in the figures are discussed at various points herein. FIG. 2 illustrates a computing system 102 or other system configured by one or more of the IPSDI functionality enhancements taught herein, resulting in an enhanced system 202. In some embodiments, an enhanced system 202 includes a single machine, a local network of machines, machines in a particular building, machines used by a particular entity, machines in a particular datacenter, machines in a particular cloud, or another environment 100 that is suitably enhanced as taught herein.

FIG. 3 is a dataflow diagram 300 of another example family of enhanced systems 202 which are each configured with IPSDI functionality 204. In some embodiments consistent with FIG. 3, components shown in FIG. 2 or other figures are also present.

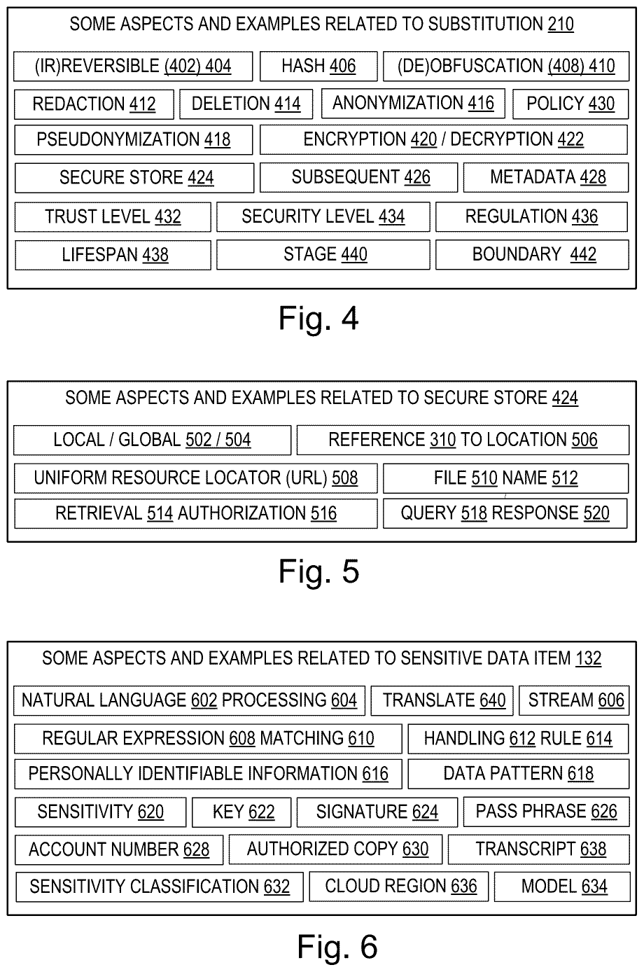

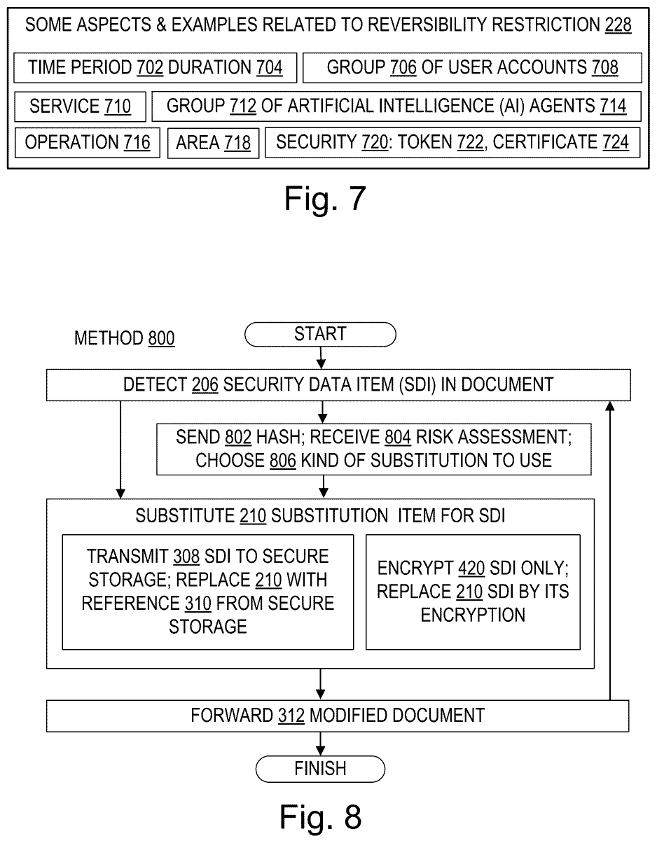

FIGS. 1-7 show reference numerals for some items and some aspects of items that relate to IPSDI. Failure to receive a reference numeral does not make an item insignificant. FIGS. 1-7 do not individually or collectively or in any subset fully define a comprehensive summary of all aspects of enhanced systems 202 or all aspects of IPSDI functionality 204. Nor is any figure of FIGS. 1-7 or any group of figures of FIGS. 1-7 by itself a comprehensive summary of all aspects of an environment 100 or another computational context 100 of an enhanced system 202.

The other figures are also pertinent to systems 202. FIGS. 8 to 13 are flowcharts which illustrate some methods of IPSDI functionality 204 operation in some systems 202.

In some embodiments, the enhanced system 202 is networked through an interface 226. In some, an interface 226 includes hardware such as network interface cards, software such as network stacks, APIs, or sockets, combination items such as network connections, or a combination thereof.

Some embodiments include a computing system 202 which is equipped, structured, or otherwise configured to utilize or provide IPSDI functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous address block or of a single kind, e.g., a memory 112 may include hard drive memory as well as volatile RAM, and may include memories that are physically located on different machines 101, but “memory” alone also includes systems with multiple memories. Similarly, the phrase “processor set” is used to emphasize that a processor 110 is not necessarily confined to a single chip or a single machine 101, but “processor” alone also includes systems with multiple processors.

All sets herein are non-empty unless described otherwise. At a given point in time any data structure implementing a set identified in this description is empty, or is non-empty, depending on the embodiment and the circumstances. However, even an empty set is defined and detectable in the system 202 as a set when an embodiment includes a data structure implementing the set. The absence of members of a set is not the absence of the set itself.

In this example, a computing system 202 includes at least one processor 110, which is in operable communication with at least one digital memory 112. The at least one digital memory includes volatile storage and non-volatile storage unless indicated otherwise.

Some embodiments include a computing system 202 including: a digital memory 112; a processor 110 in operable communication with the digital memory; a sensitive data detection procedure 208 including instructions 116 which upon execution by the processor detect 206 a sensitive data item 132 which is embedded in a digital document 134 and which occupies less than three-quarters of the digital document by size 232; a substitution data item determination procedure 216 including instructions 116 which upon execution by the processor determine 214 a substitution data item 212; a document modification procedure 220 including instructions 116 which upon execution by the processor modify 218 the digital document by reversibly substituting 210 the substitution data item for the sensitive data item within the digital document; and an interface 226 including instructions 116 which upon execution by the processor forward 312 the modified digital document 314, 134.

Sizes 232 are measured in one or more of bits, bytes, packets, or other storage or transmission units, throughout this disclosure. It is sufficient for sizes in any of the units to meet a stated condition comparing them, even when sizes measured in some other unit do not meet the condition.

In some embodiments, the substitution data item determination procedure 216 includes instructions 116 which upon execution by the processor obtain 1320 a user input 230, and determining 214 the substitution data item 212 depends on at least the user input.

In some embodiments, the substitution data item 212 includes a file name 512 or a uniform resource locator (URL) 508, and the substitution data item identifies 1326 a secure store 424 which contains the sensitive data item.

In some embodiments, the sensitive data item includes at least one of: a pass phrase 626 (a password is one example of a pass phrase), an API key 622, a security token 722 (e.g., a token per se, or serialized certificate plus private keys or container ids), a security key 622 (e.g., a symmetric security key 622, or an asymmetric encryption security key 622), an account number 628 (e.g., for a bank, credit union, credit card, debit card, brokerage, or mortgage account), a token signature 624, a signature (digital or personal) 624, or a personally identifiable information data item 616 (e.g., name, contact data, government or company identification numbers, account number, demographic data, physical characteristics including but not limited to biometric data, IP address, device address or identifier, online activity history). Other examples of SDI 132 in some scenarios include confidential information such as a tented or otherwise confidential project name, project schedule, deadline, list of candidates, etc.

In some embodiments, the sensitive data detection procedure 208 includes instructions which upon execution by the processor perform at least one of: natural language 602 processing 604 of at least a portion of the digital document; regular expression matching 610 of at least a portion of the digital document; combining 1328 at least a portion of the digital document with an authorized copy 630 of personally identifiable information 616; deobfuscation processing 408 of at least a portion of the digital document; translating 640 at least a portion of the digital document by at least one of: decoding (e.g., from base64), scanning (e.g., as part of a programming-language-specific static analysis), parsing (particularly but not necessarily only to confirm a source code is present), or decompressing; comparing at least a portion of the digital document to a predefined rule which specifies sensitive data handling; or comparing 1330 at least a portion of the digital document to a predefined pattern 618 which specifies sensitive data. Scanning targets and parsing activity vary in some embodiments according to the context 100, e.g., in an IDE, scanning and parsing are configured for C# (a.k.a. C-sharp) or other programming language source code, in telemetry streams they are configured for JSON or a markup language such as XML in data records, and in a word processor document, they are configured for base64 encoded data.

With regard to natural language processing, some embodiments detect and encrypt data that is considered sensitive for reasons specified via language model training, or language model prompt instructions. This supports a broad set of sensitive data 132, e.g., the timing of a military strike or a publicity campaign, details of a speech or a proposal, descriptions of particular persons or entities, results of semantic analysis of copied code snippets or otherwise interpreting the data in an attempt to detect a secret that can be inferred or construed from the data (rather than simply expressed as discrete pattern to a regex for instance), and many other kinds of data.

In some embodiments, the substitution data item determination procedure 216 includes instructions which upon execution by the processor perform at least one of: classifying 632 the sensitive data item according to its sensitivity 620; comparing 1330 at least a portion of the digital document to a predefined rule 614 which specifies sensitive data handling 612 (handling 612 includes one or more of detection 206, substitute determination 214, document modification 218, forwarding 312); or comparing 1330 at least a portion of the digital document to a predefined pattern 618 which specifies sensitive data.

Some embodiments include a sensitive data item access procedure 224 that includes instructions 116 which upon execution by the processor perform at least one of: gets 1322 a copy of the sensitive data item from a secure store 424; or gets 1322 a copy of the sensitive data item by reversing 404 a transformation 306 which occurred as part of substituting 210 the substitution data item for the sensitive data item.

Some embodiments include instructions 116 which upon execution by the processor substitute 210 a subsequent 426 substitution data item 212 for the substitution data item 212. That is, the protection includes substitution 1324, 210 stages 440, e.g., a first quick local substitution to provide at least some protection, such as an AES-GCM or ChaCha20-Poly1305 or Twofish or Blowfish encryption, followed by a second potentially slower and not necessarily local substitution, such as AES-256 encryption and storage in a vault 424, to provide greater protection. AES-GCM is Advanced Encryption Standard in Galois/Counter Mode. Some embodiments utilize three or more stages 440, with respective subsequent 426 substitution 1324, 210 data items 212.

In some embodiments, the subsequent substitution data item differs from the initial substitution data item in at least one of: a particular transformation algorithm 306 generated only one of the subsequent substitution data item or the substitution data item; a particular secure store 424 contains only one of the subsequent substitution data item or the substitution data item; a different trust level 432 (the confidence in the integrity and reliability of a particular entity) or a different security level 434 (the set of procedures and mechanisms enabled to protect a system or data from unauthorized access, use, disclosure, disruption, modification, or destruction), or both, is associated with the substitution data item than is associated with the subsequent substitution data item; a different sensitive data policy 430 or a different regulatory compliance requirement 436, or both, is associated with the substitution data item than is associated with the subsequent substitution data item; a different retrieval authorization 516 is associated with the substitution data item than is associated with the subsequent substitution data item; or a different lifespan 438 is associated with the substitution data item than is associated with the subsequent substitution data item.

In some embodiments, at least a portion of the digital document 134 contains sensitive data 132 which is detected 206 by the sensitive data detection procedure, the sensitive data has a total sensitive data size 232 in bits, the digital document portion has a document portion size 232 in bits, and the total sensitive data size is between eighty percent and one hundred percent of the document portion size.

### IPSDI Processes (a.k.a. Methods)

Processes (which are also referred to as “methods” in the legal sense of that word) are illustrated in various ways herein, both in text and in drawing figures. FIGS. 8 to 13 each illustrate a family of IPSDI methods 800, 900, 1000, 1100, 1200, and 1300 respectively, which are performed or assisted by some enhanced systems, such as some systems 202 or another functionality enhanced system as taught herein. Method families 800 through 1200 are each a proper subset of method family 1300. Moreover, activities are identified in FIGS. 1 to 7 as explicit or implicit method steps are likewise incorporated into method 1300, e.g., computationally reading and writing a document 134, communicating with a language model 634, 714, reading and parsing a policy 430, identifying a trust level 432 or a security level 434 from tags or other data, and so on. Also, steps that are not expressly tied herein to a particular reference number are not thereby excluded from method 1300. These diagrams and flowcharts are merely examples; as noted elsewhere, any operable combination of steps that are disclosed herein may be part of a given embodiment when called out in a claim.

Technical processes shown in the Figures or otherwise disclosed are performed automatically, e.g., by an enhanced system 202, unless otherwise indicated. Related non-claimed processes may also be performed in part automatically and in part manually to the extent action by a human person is implicated, e.g., in some situations a human 104 types text into a user interface. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 13. FIG. 13 is a portion of the textual and figure drawing examples of embodiments provided herein and the descriptions of embodiments provided herein. In the event of any alleged inconsistency, lack of clarity, or excessive breadth due to an interpretation of FIG. 13, the other content of this disclosure shall prevail over that interpretation of FIG. 13.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 1300 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 13 or any other figure to be non-operable, the sequence S is not within the scope of any claim. Any assertion otherwise is contrary to the present disclosure.

Some embodiments provide or utilize an IPSDI method 1300 which is performed by a computing system. The method includes: detecting 206 a sensitive data item 132 which is embedded in a digital document 134, the sensitive data item being less than an entire human-readable portion 130 of the entire digital document (human-readable means in natural language as opposed to machine language or binary-only data; human-readable data is represented internally in binary but also routinely decoded to natural language); modifying 218 the digital document by substituting 210 a substitution data item 212 for the sensitive data item 132 within the digital document, the substituting reversible 404 in that the substitution data item is free of redaction 412 relative to the sensitive data item; and forwarding 312 the modified digital document. Redaction 412 is understood herein to be irreversible 402 (aka permanent redaction) when a redacted document has no unredacted copy, which is presumed.

As one example of “less than a human readable portion of a digital document” consider a scenario in which an entirely new chat is occurring between two user accounts, in which the sole message is one account sending the other account a password that gets substituted. Unless stated otherwise, this scenario is presumptively covered by the condition “less than a human readable portion of a digital document” in the presence of other human readable content such as user names and the title of the chat.

In some embodiments, the substitution data item includes a result of a reversible 404 transformation 306 of the sensitive data item. In some, the method excludes 1304 generating 1308, 306 the substitution data item by any of: hashing 406 the sensitive data item, irreversibly obfuscating 410 the sensitive data item, irreversibly redacting 412 the sensitive data item, deleting 414 the sensitive data item, anonymizing 416 the sensitive data item, or irreversibly pseudonymizing 418 the sensitive data item. In some, the method includes 1306 generating 1308 the substitution data item by transforming 306 the sensitive data item by at least one of: encrypting 420 the sensitive data item (which is reversible by a corresponding decryption 422), reversibly obfuscating 410 the sensitive data item (which is reversible by a corresponding deobfuscation 408), or reversibly pseudonymizing 418 the sensitive data item (which is reversible by a corresponding restoration of the original sensitive data item, e.g., via lookup in a table of pseudonyms and the original data they represent).

In some embodiments, the substitution data item 212 includes a reference 310 (e.g., URL, index, pointer, access number, other identifier) to a location 506 in a secure store 424, the sensitive data item being unretrievable 514 from the secure store via the reference in the absence of a retrieval authorization 516 (otherwise the substitution provides little or no protection). In some, and the method further includes: transmitting 308 a copy of the sensitive data item to the secure store (for storage therein and to obtain in response the reference 310); and keeping 1310 the modified digital document free of the retrieval authorization while forwarding 312 the modified digital document (otherwise the substitution provides little or no protection).

In some embodiments, the method includes, in response to detecting 206 the sensitive data item, at least one of: creating 1312 the secure store (e.g., via an API), and then the transmitting 308 transmits the copy of the sensitive data item to the secure store; creating 1312 the secure store, and then the transmitting transmits an encrypted 420 copy of the sensitive data item to the secure store; the transmitting 308 transmits the copy of the sensitive data item to a local 502 secure storage mechanism 424 which is on a same machine as the sensitive data item (e.g., storage in or similar to a local password file 510), the local secure storage mechanism thereby being the secure store; the transmitting 308 transmits an encrypted 420 copy of the sensitive data item to a local secure storage mechanism which is on a same machine as the sensitive data item, the local secure storage mechanism (e.g., a user temp directory, secured by account access control to the machine environment) thereby being the secure store; the transmitting 308 transmits the copy of the sensitive data item to a global 504 secure storage mechanism which is on a different machine than the sensitive data item, the global secure storage mechanism thereby being the secure store; or the transmitting 308 transmits an encrypted 420 copy of the sensitive data item to a global secure storage mechanism which is on a different machine than the sensitive data item, the global secure storage mechanism thereby being the secure store.

In some embodiments, the method includes: extracting 1314 metadata from the sensitive data item or its context 100, or both; and selecting 1316 the secure store in response to at least the metadata. In addition to other examples herein, some metadata 428 distinguishes an admin secret from a read-only secret, some metadata 428 specifies a level of authorization of the secret (which includes the timestamp, permissions, etc., in some scenarios), some metadata 428 specifies a level of sensitivity in a business context of the resource the secret provides access to (e.g., in a pipeline that builds and releases internal tools code versus access to production components).

In some embodiments, the method extracts timestamp metadata 428, which is used, e.g., to determine whether a security key 622 has expired; expired keys receive minimal protection (even expired keys exhibit format information that can assist attackers).

In some embodiments, the method extracts deployment metadata 428, e.g., an authorized deployment cloud status such as public, private (e.g., air-gapped), or governmental, an authorized deployment cloud region 636 or tenant or tenant group identifier, an authorized deployment data center identifier, an authorized deployment cloud account 708 identifier, an authorized sensitive data manager identifier, an authorized deployment cloud status of development test environment, or an authorized deployment cloud status of preproduction environment. Such deployment information, together with external or coded-in policy 430 data, influences or determines which secure store 424 to utilize. Origination metadata 428 such as a minting service identifier, a minting provider identifier, a minting cloud region identifier, a minting cloud tenant identifier, a minting cloud tenant group identifier, a minting data center identifier, or a minting cloud account identifier, similarly operates subject to policy to influence or determine which secure store 424 to utilize.

In some embodiments, the method extracts test metadata 428 or test behavior metadata 428 which indicates a dummy secure store, or no secure store, is a suitable choice. Such metadata 428 indicates at least one of: the sensitive data item 132 is actually a test item whose unauthorized exposure is an acceptable risk event during testing of the security 720 functioning of the computing system, the sensitive data item 132 is a test item whose unauthorized exposure is an expected event during testing of the security functioning of the computing system, or the sensitive data item 132 is a testing artifact having a fictional provider.

In some embodiments, the method includes sending 802 a hash 406 of the sensitive data item to a risk assessor 304, receiving 804 a risk assessment 302 of the sensitive data item from the risk assessor, and choosing 806 the substitution data item in response to at least the risk assessment.

In some embodiments, the method includes intercepting 1318 a streaming transmission of the digital document. Some examples of streamed documents 134 include, e.g., a video conference chat communication, a live video transcript 638, an endless stream of telemetry data into which a system 102 injects encrypted versions of detected sensitive data. This is not a complete list of streamed documents.

### IPSDI Configured Storage Media

Some embodiments include a configured computer-readable storage medium 112. Some examples of storage medium 112 include disks (magnetic, optical, or otherwise), RAM (random access memory), EEPROMs (electronically erasable read-only memories) or other ROMs (read-only memories), and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, is configured in the embodiment using items in the form of data 118 and instructions 116, read from a removable storage medium 114 and/or another source such as a network connection, to form a configured storage medium. The foregoing examples are not necessarily mutually exclusive of one another.

The configured storage medium 112 is capable of causing a computer system 202 to perform technical process steps for providing or utilizing IPSDI functionality 204 as disclosed herein. The Figures thus help illustrate configured storage media embodiments and process (a.k.a. method) embodiments, as well as system and process embodiments. In particular, any of the method steps illustrated in FIG. 3 or FIGS. 8 to 13, or otherwise taught herein, may be used to help configure a storage medium to form a configured storage medium embodiment.

Some embodiments use or provide a computer-readable storage device (a.k.a. medium) 112, 114 configured with data 118 and instructions 116 which upon execution by a processor 110 cause a computing system 202 to perform an IPSDI method 1300. This method 1300 includes: intercepting 1318 a transmission 316 (e.g., streaming, file system read/write, network transmission) of a digital document; detecting 206 a sensitive data (one or more items 132, not necessarily contiguous) which is embedded in the digital document, the sensitive data 132 being less than a third by size 232 of the entire digital document; modifying 218 the digital document by substituting 210 a substitution data (one or more items 212, not necessarily contiguous) for the sensitive data within the digital document, the substituting reversible 404 in that the substitution data includes a redaction 412 of between none of the sensitive data and at most one fifth of the sensitive data, the substitution data being less than a third by size 232 of the entire digital document; and forwarding 312 the modified digital document.

In some embodiments, the method includes restricting 228 reversibility 404 of the substituting 210 to at least one of: a specified time period 702 having a duration 704 greater than zero; a specified computational service 710; a specified user account 708; a specified group 706 of user accounts 708; a specified artificial intelligence agent 714; a specified group 712 of artificial intelligence agents 714; an operation 716 which is authorized by a specified security token 722 or a specified security certificate 724; an operation 716 which is performed on a specified machine 101; or an operation 716 which is performed within a specified geographic area 718.

For example, in one scenario after a link 310 is created, the link is valid for only fifteen minutes. This allows sharing a secret 132 in real-time, but provides security by wiping out the access capability after the secret is promptly retrieved. More generally, in some embodiments and scenarios a timeout 704 limits 228 the timeframe for retrieval of the secret. Some embodiments and scenarios allow an account to look at a secret 132 a single time and then encrypt the secret 132 again, with subsequent retrieval subject to a subsequent authorization flow. Alternately, some embodiments and scenarios destroy the secret 132 after the secret has been retrieved a single time. Such restrictions 228 are configurable in some embodiments, e.g., via a user account interaction or an admin account interaction. Some embodiments permit a user account or an admin account which owns or controls access to deem sensitive data 132 as no longer subject to encryption or other protections under functionality 204 (e.g., in the event of a false positive result of detection 206); some of these embodiments revert support 204 that was previously configured.

In some embodiments, the modifying 218 includes extracting 1314 a location metadata 428 from the sensitive data, and selecting 1316 a secure store in response to at least the location metadata, and the substitution data includes a reference 310 to a storage location in the secure store.

In some embodiments, the modifying 218 includes extracting 1314 a user account metadata 428 or other metadata 428 from the sensitive data, and selecting 1316 a secure store in response to at least the user account metadata, and the substitution data includes a reference 310 to a storage location in the secure store. In some embodiments, the modifying 218 includes extracting 1314 metadata 428 from a computational context 100 of the sensitive data item 132, and selecting 1316 a secure store in response to at least the metadata 428.

In some embodiments, the modifying 218 includes querying 518 a secure store, and opting 1316 whether to store the sensitive data in the secure store in response to at least a response 520 to the querying.

### Additional Observations on IPSDI

Support for the discussion of IPSDI functionality 204 herein is provided under various headings. However, it is all intended to be understood as an integrated and integral part of the present disclosure's discussion of the contemplated embodiments. This disclosure is meant to be understood as a whole. In particular, this disclosure is unlikely to be fully and properly understood during or after only a single top-to-bottom pass through its text. For a full and proper understanding, most if not all readers will also use keyword searches, reference numeral searches, correlation of the specification text with the drawing figures, correlation of the claims with the rest of the text and with the drawing figures, and other nonlinear reading approaches, in addition to reading the full text from top to bottom.

One of skill will recognize that not every part of this disclosure, or any particular details therein, are necessarily required to satisfy legal criteria such as enablement, written description, best mode, novelty, nonobviousness, adequate claim support via technical teachings in the description, inventive step, or industrial applicability. Any apparent conflict with any other patent disclosure, even from the owner of the present subject matter, or any reference external to the present disclosure, has no role in interpreting the claims presented in this patent disclosure. It is in the context of this understanding, which pertains to all parts of the present disclosure, that examples and observations are offered herein.

For a variety of reasons, people sometimes share passwords, API keys, and other forms of secret tokens with each other. Although many of the channels used are insecure and generally non-compliant with security policies and regulations, it is not unusual for people to send such items over email, video conferencing messages, or other vulnerable channels. Some data loss prevention scenarios statically detect at least some of these communications, but their response is a “hard block” of the communication, which gives the user an error message and prevents them from proceeding. This block sometimes results in the user circumventing the blocking mechanism, e.g., by obfuscating the non-compliant token via (unencrypted) archive attachment, or introducing spaces or other characters in the token. At a minimum, the block adds friction and delays while a user tries to circumvent it.

Full document encryption has helped improve security by encrypting substantially all user-generated content of a document, including any sensitive data embedded within the document. But that approach does more work, and takes more time, than is strictly necessary to protect the sensitive data. As a result, users take an ad hoc approach and send passwords or other sensitive data by email, voice mail, SMS, or other channels chosen on the fly, which leads to inconsistent protection.

Some embodiments described herein detect sensitive data within a document (which could be a streamed document, or not), and substitute other data in place of the sensitive data. In some scenarios the substituted data is an encryption or other reversible transformation of the sensitive data. In other scenarios, the substituted data is a reference to a location in a secure store that contains the sensitive data. These functionalities 204 are suitable for inclusion in, or integration with, practical applications 122 such as video conferencing or other collaboration tools, office productivity tools, software development tools, and other offerings that allow users to transmit sensitive data to one another.

Some embodiments provide or utilize a transparent intervention system for detecting inline secrets moving across a boundary 442 (e.g., machine, network, region, cloud, area, authorization, or other), automatically re-packaging 210 them, and replacing them inline with an opaque reference 310 acquired 1102 from a secure store, before moving 312 the embodying communication across the boundary.

Some embodiments allow users to continue using familiar application interfaces for instant messaging, email, support tickets, etc. But the application is enhanced with functionality 204 to automatically detect the secret and then convert only that part of the communication to secure it. In one example, the client side of a system operates before anything is sent to a remote server, leaving the communication untouched except for the secret, which it routes 308 to a secure storage mechanism (e.g., a key vault storage), and then automatically puts a reference 310 to the secret in the communication. In some cases, this happens transparently, in that the sending and receiving clients automatically do the transformation so the user is unaware of the underlying storage mechanism. In other cases, the modification is more visible, e.g., when the secret is replaced in real-time with a URL link to its secure location.

Some embodiments integrate functionality 204 with software authoring tools, e.g., in the context 100 of IDE-driven development. An IDE is an integrated development environment 100. In this context, upon detecting a secret the inline conversion 218 in some cases entails creating a permanent secret store or migrating the secret to a local secret storage solution. In these cases, the secret management is not limited to a short-term protection for a specific message or secret transmittal, but instead provides a more permanent solution which lasts weeks or more beyond the receipt of the modified communication 134.

In some scenarios, a key 622 has data residency information 428 stamped into it. Some embodiments automatically route such keys for storage in a key vault 424 instance or a backing storage 424 in a compliant region even if the rest of the communication is not stored there. More generally, some embodiments utilize metadata 428 and/or other contextual data 118 to assess data sensitivity 620 and determine where the original SDI 132 will be stored. Some locate a storage vault in the same region or in a particular discrete cloud instance (e.g., particular government cloud, sovereign cloud, and/or air-gapped cloud) as the metadata embedded in a key. Some embodiments include or consult a local oracle functionality which identifies static data as opposed to a remote inventory of keys, identifies which customer owns the SDI 132, or takes other assessment actions. Some embodiments correlate an identifier received from a remote oracle to make a local decision.

By de-coupling the general communication channel and the storage mechanism, some embodiments satisfy different auditing, logging, and data residency requirements.

Some embodiments provide real-time user education about best practices for secrets.

Some embodiments encrypt the sensitive data 132 with the intended recipient's public key, without encrypting the entire general communication. Then the encrypted secret is sent with the rest of the communication 134. The user interface 226 handles protection transparently, with the enhanced tool encrypting and decrypting the data 132 such that the user doesn't have to think about it.

In some embodiments, before choosing an action 210, one or more external systems are consulted by sending 802 them a secure hash of the secret as well as metadata 428 about the context 100. Some examples of metadata 428 include data 428 identifying a location or source of potential or actual exposure (such as an administrator with authority over a video conferencing channel of group in which a pass phrase or other SDI 132 is copied, or the owner or creator of a document 134 whose interior is subject to functionality 204), data 428 identifying a source 104 or a recipient 104 account of a document 134 transmission (e.g., functionality 204 in some scenarios provides or invokes additional security protection for an account operating in a leadership role which is therefore subject to particular attacker scrutiny or more likely to contain SDI 312 than non-leadership accounts), or metadata about indirect storage locations (e.g., some stores 424, such as government-funded stores or critical mission stores, are subject to their own respective security policy 430 or compliance 436 policy or both). From this, risk 302 is assessed and selection of the communication or substitution details, or both, is influenced according to the risk assessment. For example, a choice is sometimes made between more granular blocking and encrypting inline.

In some embodiments and scenarios, the real-time user training 1334 is selected and performed based on blast radius and risk. For example, if the system detects a production key is sent, it offers one training or hard-blocks it, whereas if the detected data 132 is a personal key the system 202 does inline encryption with some lighter user education or training. More generally, in some embodiments and scenarios, reporting 1334 outputs data identifying at least one of: which particular secrets 132 have been mishandled by plaintext inclusion in the digital documents (and been subsequently protected 204), or a list of user names who should be promptly directed into user training or otherwise coached for security. When reporting data that identifies a secret itself, some embodiments provide a deterministic non-reversible representation of the secret for that reporting; the secret per se is not reported in the clear (a.k.a. as plaintext). Some embodiments monitor activity in or by implicated user account(s) or admin account(s) after retrieval of an SDI 132, as additional protection functionality 204.

As another example, in one scenario an application reads secrets from environment variables. Those secrets are sensitive and particular care is prudent, to prevent them from being disclosed into a crash dump. Some embodiments detect 206 environment variables with the secrets in memory 112 (transmission in this case being reading memory 112 or writing memory 112), and encrypt the secret in memory or offload it to a key vault. Some embodiments then patch the runtime in order to support a capability to decrypt or otherwise retrieve the secret under protected conditions, so that the application code using the secrets remains unaware of the underlying storage mechanism of the protected secret.

Some embodiments detect a secret moving across a boundary. They transform the secret into a uniquely identifiable representation which is moved across the boundary in place of the secret.

Some embodiments re-package a secret, retaining a copy of the secret in a secure, compliant store and only transmitting an opaque reference to the secret across the boundary. In some embodiments, the store 424 is a geographically isolated store.

Some embodiments conduct telemetry and identify a blast radius for potential exposure of the sensitive data. In particular, some embodiments perform a hard block if the potential exposure reaches production software or services.

Some embodiments check whether a sensitive data item copy is already stored in a secure store 424, and generate a link 310 to the existing copy rather than storing another copy, thereby reducing or minimizing the number of store entries that are created.

In some embodiments, when a sensitive data item that includes a development operations personal access token is detected, the validity of that access token is immediately revoked. This effectively substitutes 210 an invalid token for a valid token, even if the same bits represent the token within the original message and within the modified message 134. In a variation, some embodiments mark the token 132 as a candidate for auto-revocation.

In some embodiments, when a secret has expired, the system 202 lets it go through without requiring it to be sent or stored securely.

Some embodiments automatically replace a secret for test purposes, e.g., by rewriting 218 the secret for AI agent consumption. Submission of data to an AI agent often risks exposure of the data consumed by the AI agent, e.g., an inference service.

Some embodiments effectively place trust in certain AI agents or tools more than others, but nonetheless mask an SDI 132 at least temporarily from access. Some embodiments employ a different trust level for respective different accessors 222, and for different vaults 424. In some, for example, per policy 430 an admin 104 can't see data 132 but can specify various kinds of sensitive data and can specify limits on access to it.

Some embodiments retain SDI 132 of specified conversations for a regulatory compliance period, e.g., N months or M years.

Some embodiments query an intended recipient 104, e.g., by posting a question such as “Do you want to receive this item someone is sending to you?” Further action is then conditioned upon the user input received in response to the question.

In some embodiments, user interface (UI) actions are performed in response to user input, modification, or other triggers. In some scenarios, he secret is replaced with a link that points to the new secret storage location that holds it, and the UI displays the link. In some, the sensitive data is replaced in the UI display by an icon that indicates the data is encrypted, and on receiving a double-click or similar input the embodiment leads a user through an authentication flow or an authorization flow to a visualization of the original data.

In one scenario, a user is not yet a platform customer for the target secret store. There is no available instance of a secret store yet. The enhanced system 202 detects a compromised secret key at code authoring. The developer team is not on the platform, but will be onboarded. The developer team does not have an existing secret store, so the system 202 creates a key vault instance. There is no existing object storage for the key and so one is created. The newly created key vault instance is populated with the compromised secret key. Code under development is updated to consume the key-vault-stored secret key.

Some embodiments do one or more of: securing data 132 in advance of transmit (via encryption), securing it in transit (e.g., via HTTPS), and securing it at rest.

Some embodiments parse a digital document in a predefined way, e.g., by looking for delimiters such as whitespace. Some utilize a regex or other parsing mechanism to divide a document into portions during detection 206. In some, running a regex provides a preliminary document portion, which is further refined by obtain a sub-portion which comprises a match or capture group within the regex.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP (Transmission Control Protocol/Internet Protocol), Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers.

For example, some embodiments address technical activities such as detecting sensitive data without employing human senses or human actions, modifying a document without employing human senses or human actions, without employing human senses or human actions, encrypting or decrypting data without employing human senses or human actions, creating a secure store without employing human senses or human actions, and many others, which are each an activity deeply rooted in computing technology. The “without employing human senses” and “without employing human actions” qualifiers are stated here explicitly to help prevent misunderstanding by some readers, but they would be understood by one of skill in the art as inherent to the embodiments. These qualifiers shall govern the interpretation of the claims even when not explicitly recited in the claims. To improve readability and reduce disclosure length, these qualifiers are not explicitly repeated throughout this disclosure, but the disclosure should be read as if they were thus repeated.

Moreover, some of the technical mechanisms discussed in this disclosure include, e.g., detection procedures 208, substitution determination procedures 216, document modification procedures 220, secure stores 424, regexes 608, language models 634, and various other particular sets of instructions 116 executable by processors 110. None of these are mental concepts or present merely on paper.

In addition, some of the technical effects discussed include, e.g., increased security by the detection of sensitive data in scenarios where whole document encryption is not performed, faster processing due to the focus 1302, decreased computational cost due to the focus, relative to other approaches, as well as solving an inconsistent protection problem which arises from an ad hoc approach to sensitive data protection. Other technical effects are also discussed herein, e.g., in the descriptions of technical benefits and technical challenges.

In short, purely mental processes, activities limited to pen-and-paper, and abstract ideas per se are clearly excluded from the scope of any claimed embodiment. Other advantages based on the technical characteristics of the teachings will also be apparent to one of skill from the description provided.

One of skill understands that the operations performed by functionality 204, and other computational activities described herein are each a technical activity which cannot be performed mentally at all, because the mechanisms in question lack I/O devices that would allow a human to somehow “read” or “write” values within the computing system as described. Hence, computing technology operational improvements such as the various examples of functionality 204 described herein are improvements to computing technology. People manifestly lack the speed and the digital communication and computation capabilities which are required to perform functionality 204 operations as taught herein.

Different embodiments provide different technical benefits or other advantages in different circumstances, but one of skill informed by the teachings herein will acknowledge that particular technical advantages will likely follow from particular embodiment features or feature combinations, as noted at various points herein.

Any generic or abstract aspects of described embodiments are integrated into a practical application, such as video conferencing or other collaboration tools, office productivity tools, software development tools, and other offerings that allow users to transmit sensitive data to one another. The foregoing are examples, not a comprehensive list of all potential practical applications of the present disclosure's teachings.

Many embodiments are suitable for implementation in a single device, but some embodiments also span multiple devices.

Some embodiments described herein may be viewed by some people in a broader context. For instance, concepts such as efficiency, reliability, redundancy, or waste may be deemed pertinent to a particular embodiment. However, it does not follow from the availability of a broad context that exclusive rights are being sought herein for abstract ideas; they are not. In particular, no claim is made to encryption activities generally, or document editing generally, as opposed to the particular functionality 204 methods, systems, and devices described and claimed in the eventual final claims based on the present disclosure.

Rather, the present disclosure is focused on providing appropriately specific embodiments whose technical effects fully or partially solve particular technical problems noted herein, e.g., in connection with one of the marker phrases “how to”, “problem”, or “challenge”, or otherwise apparent to one of skill in the art. Other systems, devices, and processes involving efficiency, reliability, redundancy, or waste are outside the present scope. Accordingly, vagueness, mere abstractness, lack of technical character, and accompanying proof problems are also avoided under a proper understanding of the present disclosure.

### Additional Combinations and Variations

Any combination of logic, components, communications, software, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, examples, operating environments, tools, peripherals, process flows, identifiers, naming conventions, notations, control flows, data flows, or other implementation choices described or used herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
JSON: JavaScript® Object Notation (mark of Oracle America, Inc.).
LAN: local area network
MAC: media access control
OS: operating system
PaaS or PAAS: platform-as-a-service
RAM: random access memory
ROM: read only memory
TPU: tensor processing unit
UEFI: Unified Extensible Firmware Interface
WAN: wide area network
XML: eXtended Markup Language

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a system. Activity within the scope of any claim based on the present disclosure excludes human action, but does allow coverage of computational action which is performed in response to human action. Software or hardware activity “on behalf of a user” accordingly refers to software or hardware activity on behalf of a user device or on behalf of a user account or a user session or on behalf of another mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” in a computing system is a computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a patent law term of art (akin to a “method”) but it is also a technical term in the computing science arts (a kind of “routine”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Functionality 204 operations discussed herein (whether recited expressly in the Figures or not), are understood to be inherently non-human. A human mind cannot interface directly with a computing device to perform the functionality 204 steps taught herein. This would all be well understood by persons of skill in the art in view of the present disclosure. Moreover, one of skill understands that functionality 204 cannot be implemented merely with conventional tools and steps, because actual implementation requires the use of teachings which were first provided in the present disclosure, e.g., teachings that support the recited technical effects and technical operations.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein is presumptively done proactively in at least some of the embodiments.

“Based on” means computationally based on at least, not based exclusively on. Thus, a calculation based on X depends computationally on at least X, and may also depend computationally on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

In claims and elsewhere herein, labels such as (a), (b), etc. in a method description are meant to aid legibility of the description, not to impose a strict order or a total ordering of actions in the method. For instance, steps labeled as (a), (b), etc. for convenience may overlap in some embodiments, or interleave in some embodiments. Step performance order may nonetheless be indicated by verb tenses, or be indicated otherwise to one of skill such as when completion of one step is a practical prerequisite to another step.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in a computer system memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a computer system hardware processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational or other electronic or electrical device step on behalf of a party of interest, with regard to a destination or object, may involve intervening action, such as any action recited in this disclosure or inherent in a step recited in this disclosure, yet still be understood as being performed directly by or on behalf of the party of interest. Example verbs listed herein may overlap in meaning or even be synonyms; separate verb names do not dictate separate functionality in every case.

Some people have asserted, outside the present disclosure, that certain verbs indicate human activity, particularly human mental activity. Regardless of their accuracy in other contexts, those assertions are not a correct and accurate basis for the interpretation of any claim supported by the present disclosure, regardless of where they were made. No reference outside the present disclosure to human action associated with a given verb can provide a legally correct basis for the interpretation of any verb recited in any claim supported by the present disclosure. For example, any and all of the accessing, detecting, determining, modifying, and restricting, and other steps described and claimed herein is artificial activity, not human activity.

It is well-established in patent law that proper interpretation of a claim begins with the claim itself, then looks to other claims, then seeks meaning for the claim and its limitations in view of the supporting specification, including the disclosure's text and any drawing figures, while applying the viewpoint of a person skilled in the art. To be reasonable, any claim interpretation must be consistent with the specification. Only if the meaning of claim language remains unclear after considering the claims and their supporting disclosure does it become proper to look for interpretive guidance at any use of the claim language outside the four corners of the patent application itself.

Relying on external assertions to establish that certain verbs denote human activity elsewhere and therefore also denote mental steps or other human activity within claims herein is legally incorrect. Such reliance is arbitrary and capricious when the specification clearly teaches that such human activity is outside the scope of the claims, as the current specification clearly teaches. Relying on such external assertions is also disrespectful of the efforts of patent practitioners and inventors to make it clear that human activity is not being claimed.

To the extent any human activity is arguably within the scope of any claim based on the present disclosure, that human activity scope is hereby expressly disclaimed and expressly disavowed. Human-machine interaction may be properly noted in a claim for context, e.g., when a claim recites that a user input is received by a computing system. But only the portion of the effective claim scope which is computational and supported herein by the description of computing hardware, interfaces, algorithms, data structures, and/or other non-human mechanisms, as understood by one of skill in the art, is retained.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

A list of multiple reference numerals given with an item, e.g., language similar to “item 1, 2, 3”, indicates that the item is an example of a respective category associated with each listed reference numeral. For example, “laptop 101, 102” indicates that a laptop is both a machine 101 and a computing system 102. A distinction in this example is that a computing system 102 contains one or more machines 101, whereas reference numeral 101 refers to a single machine, e.g., a single laptop, a single smartphone, a single workstation, a single Internet of Things device, etc. However, reference numerals for more general categories are often omitted herein for better readability, particularly when one of skill would acknowledge that the more general category encompasses a more specific category whose reference numeral is recited.

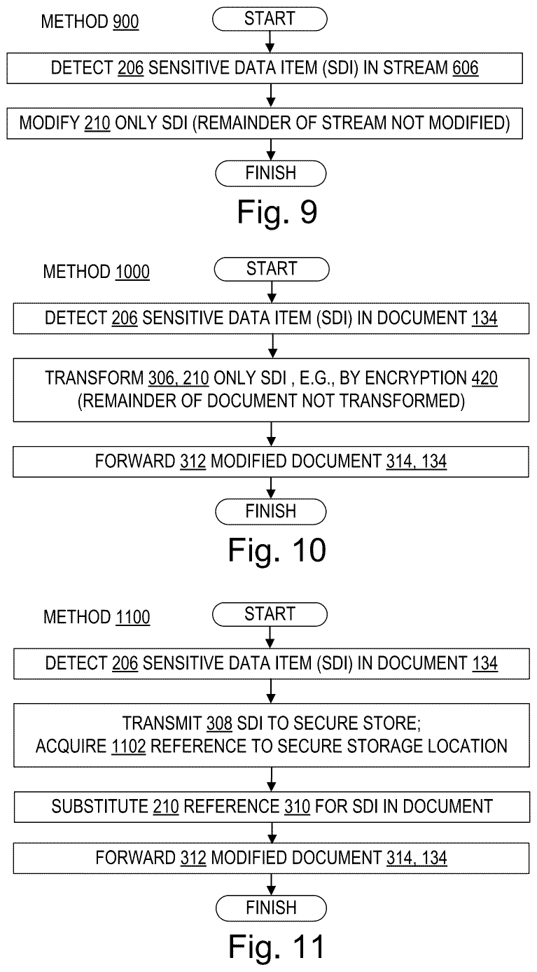

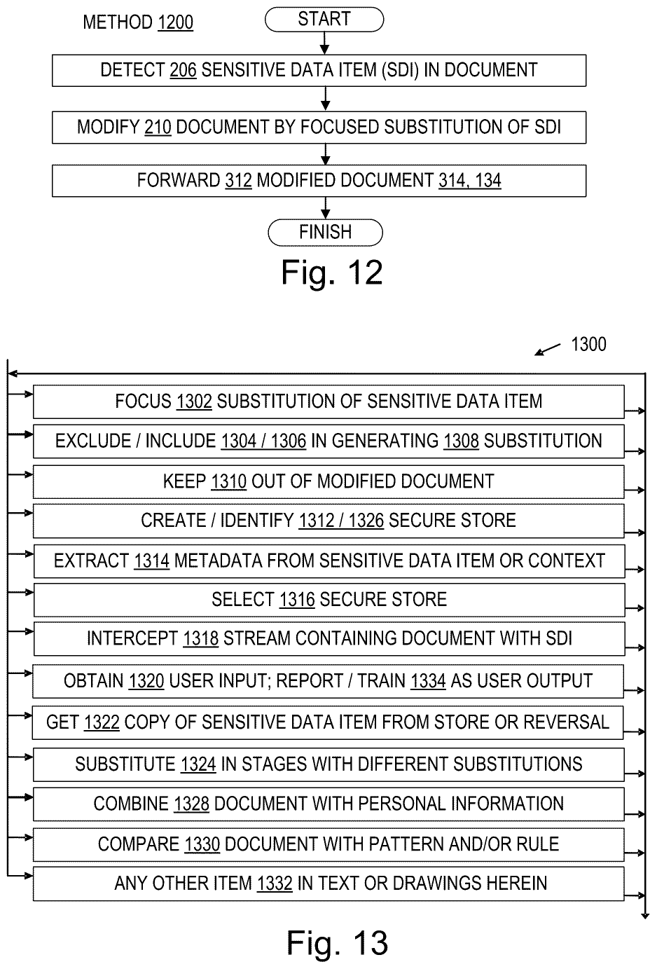

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, web browsers, CIDFP software, security controls; hardware tools; computational
124 cloud, also referred to as cloud environment or cloud computing environment
126 display screens, also referred to as “displays”
128 hardware, software, or hardware-software combination that is not otherwise associated with a reference numeral 106, 108, 110, 112, 114, e.g., power supply, application program interface (API), network interface
202 enhanced system, i.e., system 102 enhanced with functionality 204 as taught herein
204 IPSDI functionality (also referred to as functionality 204 and other terms associated with reference numeral 204), e.g., a mechanism which performs or is configured to perform steps 206 (SDI detection) and 218 (document modification), or steps 218 (document modification) and 312 (document forwarding), or any mechanism which performs or is configured to perform a sequence of sensitive data protection activities first disclosed herein, or a sequence of cybersecurity activities first disclosed herein, or to perform a novel method 1300 first disclosed herein
226 interface, e.g., network interface card, API, user interface, language model interface, or other mechanism by or through which separable items communicate in a computing system, where examples of separable include physically separable, separately compilable, separately installable, or separably replaceable without loss of functionality
800 flowchart; 800 also refers to IPSDI methods that are illustrated by or consistent with the FIG. 8 flowchart or any variation of the FIG. 8 flowchart described herein
900 flowchart; 900 also refers to IPSDI methods that are illustrated by or consistent with the FIG. 9 flowchart or any variation of the FIG. 9 flowchart described herein
1000 flowchart; 1000 also refers to IPSDI methods that are illustrated by or consistent with the FIG. 10 flowchart or any variation of the FIG. 10 flowchart described herein
1100 flowchart; 1100 also refers to IPSDI methods that are illustrated by or consistent with the FIG. 11 flowchart or any variation of the FIG. 11 flowchart described herein
1200 flowchart; 1200 also refers to IPSDI methods that are illustrated by or consistent with the FIG. 12 flowchart or any variation of the FIG. 12 flowchart described herein
1300 flowchart; 1300 also refers to IPSDI methods that are illustrated by or consistent with the FIG. 13 flowchart or any variation of the FIG. 13 flowchart described herein; the FIG. 13 flowchart, which incorporates the flowcharts of FIGS. 8 through 12 plus the steps implicit or express in FIGS. 1 through 7, and all other steps taught herein, or methods that are illustrated by or consistent with any variation of the FIG. 13 flowchart described herein; all IPSDI method steps are computational or otherwise artificial, not human activity
1332 any step or item discussed in the present disclosure that has not been assigned some other reference numeral; 1332 may thus be shown expressly as a reference numeral for various steps or items or both, and may properly be inserted as a reference numeral (in the current disclosure or any subsequent patent application which claims priority to the current disclosure) for various steps or items or both without thereby adding new matter

### Conclusion

Some embodiments detect 206 keys 622 or other sensitive data 132 in a document 134, and modify 218 the document or surrounding data structures (e.g., key validity data) in order to prevent disclosure of protected data 132. Some modifications transform 306 sensitive data inline, and some modifications replace 210 the sensitive data with a reference 310 to a copy of the sensitive data in a secure store 424. In some scenarios, the secure store is created 1312 specifically for the detected data. The document is not necessarily complete at the time of modification 210; some documents are streamed 606. Some embodiments base the modification at least partially on one or more of: a risk 302 assessment, metadata 428 embedded in the sensitive data, a sensitivity level 620, a trust level 432, an intended recipient 708, a policy 430, or regulatory requirements 436, for example.

Embodiments are understood to also themselves include or benefit from tested and appropriate security controls and privacy controls such as the General Data Protection Regulation (GDPR), and to comply with all applicable laws and regulations, e.g., the European Union Artificial Intelligence Act (EU AI Act) when applicable. Use of the tools and techniques taught herein can be done together with such controls in compliance with such laws and regulations.

Although Microsoft technology is used in some examples, the teachings herein are not limited to use in technology supplied or administered by Microsoft. Under a suitable license, for example, the present teachings could be embodied in products or services provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific details, such as specific thresholds, topologies, system architectures, and specific operating environments, and thus need not appear in every embodiment. Those of skill will also understand that component identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such a standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A cybersecurity method which is performed by a computing system, the method comprising:
detecting a sensitive data item which is embedded in a digital document, the sensitive data item being less than an entire human-readable portion of the entire digital document;
modifying the digital document by substituting a substitution data item for the sensitive data item within the digital document, the substituting reversible in that the substitution data item is free of redaction relative to the sensitive data item; and
forwarding the modified digital document.

2. The method of claim 1, wherein the substitution data item comprises a result of a reversible transformation of the sensitive data item, the method excludes generating the substitution data item by any of: hashing the sensitive data item, irreversibly obfuscating the sensitive data item, irreversibly redacting the sensitive data item, deleting the sensitive data item, anonymizing the sensitive data item, or irreversibly pseudonymizing the sensitive data item, and the method comprises generating the substitution data item by transforming the sensitive data item by at least one of: encrypting the sensitive data item, reversibly obfuscating the sensitive data item, or reversibly pseudonymizing the sensitive data item.

3. The method of claim 1, wherein the substitution data item comprises a reference to a location in a secure store, the sensitive data item being unretrievable from the secure store via the reference in the absence of a retrieval authorization, and wherein the method further comprises:
transmitting a copy of the sensitive data item to the secure store; and
keeping the modified digital document free of the retrieval authorization while forwarding the modified digital document.

4. The method of claim 3, comprising, in response to detecting the sensitive data item, at least one of:
creating the secure store, and then the transmitting transmits the copy of the sensitive data item to the secure store;
creating the secure store, and then the transmitting transmits an encrypted copy of the sensitive data item to the secure store;
the transmitting transmits the copy of the sensitive data item to a local secure storage mechanism which is on a same machine as the sensitive data item, the local secure storage mechanism thereby being the secure store;
the transmitting transmits an encrypted copy of the sensitive data item to a local secure storage mechanism which is on a same machine as the sensitive data item, the local secure storage mechanism thereby being the secure store;
the transmitting transmits the copy of the sensitive data item to a global secure storage mechanism which is on a different machine than the sensitive data item, the global secure storage mechanism thereby being the secure store; or
the transmitting transmits an encrypted copy of the sensitive data item to a global secure storage mechanism which is on a different machine than the sensitive data item, the global secure storage mechanism thereby being the secure store.

5. The method of claim 3, further comprising at least one of:
extracting metadata from the sensitive data item; and selecting the secure store in response to at least the metadata; or
extracting metadata from a computational context of the sensitive data item; and selecting the secure store in response to at least the metadata; or
sending a hash of the sensitive data item to a risk assessor, receiving a risk assessment of the sensitive data item from the risk assessor, and choosing the substitution data item in response to at least the risk assessment.

6. The method of claim 1, further comprising intercepting a streaming transmission of the digital document.

7. A computing system, comprising:
a digital memory;
a processor in operable communication with the digital memory;
a sensitive data detection procedure comprising instructions which upon execution by the processor detect a sensitive data item which is embedded in a digital document and which occupies less than three-quarters of the digital document by size;
a substitution data item determination procedure comprising instructions which upon execution by the processor determine a substitution data item;
a document modification procedure comprising instructions which upon execution by the processor modify the digital document by reversibly substituting the substitution data item for the sensitive data item within the digital document; and
an interface comprising instructions which upon execution by the processor forward the modified digital document.

8. The computing system of claim 7, wherein the substitution data item determination procedure comprises instructions which upon execution by the processor obtain a user input, and wherein determining the substitution data item depends on at least the user input.

9. The computing system of claim 7, wherein the substitution data item comprises a file name or a uniform resource locator, and the substitution data item identifies a secure store which contains the sensitive data item.

10. The computing system of claim 7, wherein the sensitive data item comprises at least one of: a pass phrase, an API key, a security token, a security key, an account number, a token signature, a signature, or a personally identifiable information data item.

11. The computing system of claim 7, wherein the sensitive data detection procedure comprises instructions which upon execution by the processor perform at least one of:
natural language processing of at least a portion of the digital document;
regular expression matching of at least a portion of the digital document;
combining at least a portion of the digital document with an authorized copy of personally identifiable information;
deobfuscation processing of at least a portion of the digital document;
translating at least a portion of the digital document by at least one of: decoding, scanning, parsing, or decompressing;
comparing at least a portion of the digital document to a predefined rule which specifies sensitive data handling; or
comparing at least a portion of the digital document to a predefined pattern which specifies sensitive data.

12. The computing system of claim 7, wherein the substitution data item determination procedure comprises instructions which upon execution by the processor perform at least one of:
classifying the sensitive data item according to its sensitivity;
comparing at least a portion of the digital document to a predefined rule which specifies sensitive data handling; or
comparing at least a portion of the digital document to a predefined pattern which specifies sensitive data.

13. The computing system of claim 7, further comprising a sensitive data item access procedure that comprises instructions which upon execution by the processor perform at least one of:
gets a copy of the sensitive data item from a secure store; or
gets a copy of the sensitive data item by reversing a transformation which occurred as part of substituting the substitution data item for the sensitive data item.

14. The computing system of claim 7, comprising instructions which upon execution by the processor substitute a subsequent substitution data item for the substitution data item, and wherein the subsequent substitution data item differs from the substitution data item in at least one of:
a particular transformation algorithm generated only one of the subsequent substitution data item or the substitution data item;
a particular secure store contains only one of the subsequent substitution data item or the substitution data item;
a different trust level or a different security level, or both, is associated with the substitution data item than is associated with the subsequent substitution data item;
a different sensitive data policy or a different regulatory compliance requirement, or both, is associated with the substitution data item than is associated with the subsequent substitution data item;
a different retrieval authorization is associated with the substitution data item than is associated with the subsequent substitution data item; or
a different lifespan is associated with the substitution data item than is associated with the subsequent substitution data item.

15. The computing system of claim 7, wherein at least a portion of the digital document contains sensitive data which is detected by the sensitive data detection procedure, the sensitive data has a total sensitive data size in bits, the digital document portion has a document portion size in bits, and the total sensitive data size is between eighty percent and one hundred percent of the document portion size.

16. A computer-readable storage medium configured with data and instructions which upon execution by a processor of a computing system perform a method, the method comprising:
intercepting a transmission of a digital document;
detecting a sensitive data which is embedded in the digital document, the sensitive data being less than a third by size of the entire digital document;
modifying the digital document by substituting a substitution data for the sensitive data within the digital document, the substituting reversible in that the substitution data includes a redaction of between none of the sensitive data and at most one fifth of the sensitive data, the substitution data being less than a third by size of the entire digital document; and
forwarding the modified digital document.

17. The computer-readable storage medium of claim 16, wherein the method further comprises restricting reversibility of the substituting to at least one of:
a specified time period having a duration greater than zero;
a specified computational service;
a specified user account;
a specified group of user accounts;
a specified artificial intelligence agent;
a specified group of artificial intelligence agents;
an operation which is authorized by a specified security token or a specified security certificate;
an operation which is performed on a specified machine; or
an operation which is performed within a specified geographic area.

18. The computer-readable storage medium of claim 16, wherein the modifying comprises extracting a location metadata from the sensitive data, and selecting a secure store in response to at least the location metadata, and wherein the substitution data comprises a reference to a storage location in the secure store.

19. The computer-readable storage medium of claim 16, wherein the modifying comprises extracting a user account metadata from the sensitive data, and selecting a secure store in response to at least the user account metadata, and wherein the substitution data comprises a reference to a storage location in the secure store.

20. The computer-readable storage medium of claim 16, wherein the modifying comprises querying a secure store, and opting whether to store the sensitive data in the secure store in response to at least a response to the querying.
